(19) United States
(12) Patent Application Publication
(10) Pub. No.: US 2025/0200543 A1
(43) Pub. Date: Jun. 19, 2025

(54) SPLIT BILLING WITHOUT SUBMETERS

(71) Applicant: ITRON, INC., Liberty Lake, WA (US)

(72) Inventors: Linto VADAKKAN JOHNY, Bengaluru (IN); Aswathy SURESH, Bengaluru (IN); Chinna Theja PANCHUMARTHI, Andhra Pradesh (IN); Sandeep PASUMARTHI, Andhra Pradesh (IN); Dinkar Kumar VERMA, Bengaluru (IN)

(21) Appl. No.: 18/540,567

(22) Filed: Dec. 14, 2023

(51) Int. Cl. G06Q 20/14; G06Q 20/10; G06Q 50/06

(52) U.S. Cl. CPC G06Q 20/145; G06Q 20/102; G06Q 50/06

(57) ABSTRACT

Various embodiments disclosed herein provide techniques for enabling metering devices to determine the consumption of a commodity on a per-user basis. In various embodiments, a method includes determining, by a metering device, a consumption of a commodity by a consumption device of a plurality of consumption devices; determining, by the metering device based on one or more user-to-consumption device usage mappings between a plurality of users and the plurality of consumption devices, one or more users of the plurality of users associated with the consumption of the commodity; and assigning, by the metering device, the consumption of the commodity by the consumption device to one or more accounts associated with the one or more users.

### BACKGROUND

### Field of the Various Embodiments

The various embodiments relate generally to isolating the amount of a commodity consumed by a user of a shared facility and more specifically to split billing without submeters.

### Description of the Related Art

Most facilities, such as residential dwellings, include one or more meters for monitoring the consumption of various commodities. Consumption monitoring is the systematic process of tracking and measuring the utilization of various resources or services, such as electricity, water, natural gas, or data, often facilitated by digital technologies and sensors. Consumption monitoring provides multifaceted benefits for individuals, businesses, and society as a whole. Firstly, consumption monitoring empowers consumers with accurate insights into the resource usage patterns of their dwellings, enabling them to make informed decisions to optimize consumption and reduce costs. This transparency ensures fairer billing practices based on actual usage. Secondly, consumption monitoring is a powerful tool for promoting sustainability and environmental conservation. It encourages more responsible resource management by highlighting inefficiencies, excessive consumption, or anomalies like leaks, thus reducing waste and minimizing environmental impact. Additionally, consumption monitoring aids in forecasting and infrastructure planning by analyzing usage data, ultimately contributing to more efficient and resilient utility systems.

### BRIEF DESCRIPTION OF THE DRAWINGS

So that the manner in which the features of the various embodiments can be understood in detail, a description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system for isolating a user's consumption of a commodity according to some embodiments;

FIG. 2 is a more detailed block diagram of the system of FIG. 1 for isolating a user's consumption of a commodity according to some embodiments;

FIG. 3 is a conceptual illustration of a flow diagram for detecting and recording at a smart meter the consumption of a commodity by a smart consumption device, according to some embodiments;

FIG. 4 is a conceptual illustration of a flow diagram for detecting and recording at a smart meter the consumption of a commodity by a non-smart consumption device, according to some embodiments;

FIG. 5 is a conceptual illustration of a flow diagram for detecting and recording at a smart meter the consumption of a commodity by an augmented consumption device, according to some embodiments;

FIG. 6 is a conceptual illustration of a flow diagram for registering and configuring users and consumption devices with a smart meter, according to some embodiments;

FIG. 7 is a conceptual illustration of a flow chart for detecting and recording at a smart meter the consumption of a commodity by multiple users using multiple consumption devices, according to some embodiments;

FIG. 8 is a conceptual illustration of a flow chart for determining one or more users to which to assign consumption of a commodity, according to some embodiments; and

FIG. 9 is a block diagram of a smart meter, according to some embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

In shared facilities, such as multi-tenant housing, it is desirable to be able to isolate each user's commodity consumption and distribute the responsibility for remuneration across all responsible users in a fair and equitable manner. The ability to isolate per-user commodity consumption is advantageous for several reasons. Per-user consumption isolation and identification promotes fairness in that a user is only responsible for the commodity that the user consumes, promotes accountability in that a user is encouraged to be more consumption-conscious when the user is directly responsible for their commodity bills leading to reduced waste while providing the user increased visibility to their commodity usage patterns affect consumption when their consumption is grouped in with others. In addition, isolating per-user commodity consumption enables a user to reduce their environmental impact by providing the user with granular usage information allowing the user to modify their behavior and reduce waste, and enables a user to make the best use of time-of-use (TOU) rates. For example, if a user knows that drying clothes during off-peak hours saves them money, then the user has the control to modify their behavior and reap the benefit.

One approach to enabling per-user consumption identification is to use sub-metering. However, sub-metering has disadvantages. Sub-metering requires additional hardware, which increases expenditures. In addition, the efficacy of sub-metering is also influenced by the type of shared facility to which it is applied. For example, sub-metering is not able to provide for per-user consumption identification when a one-to-one partitioning between sub-meters and users or devices does not exist. For example, in a shared facility with a device (e.g., an HVAC device, a laundry device, a kitchen device, an entertainment device) that can be used at different times by different users or can have shared simultaneous use, sub-metering is not able to provide per-user consumption identification. Additionally, sub-metering is not able to easily facilitate changes in devices and/or users between billing cycles. Physical limitations in the commodity distribution infrastructure of the shared facility (e.g., wiring, piping) may not easily facilitate this. For example, adding or removing users or devices might require adding or removing sub-meters and/or changing the commodity distribution infrastructure within the shared facility.

In order to address these shortcomings, techniques are disclosed herein that enable metering devices to determine the consumption of a commodity on a per-user basis. These techniques provide for per-user commodity consumption isolation and identification without the need for expenditures in hardware submetering or commodity distribution infrastructure changes required to accommodate submetering. The techniques also provide for the addition or removal of users and/or consumption devices at any time, and not just at billing cycle boundaries. The techniques also work equally well for shared facilities without a granular mapping between consumption devices and/or other divisions (e.g., rooms in a shared facility).

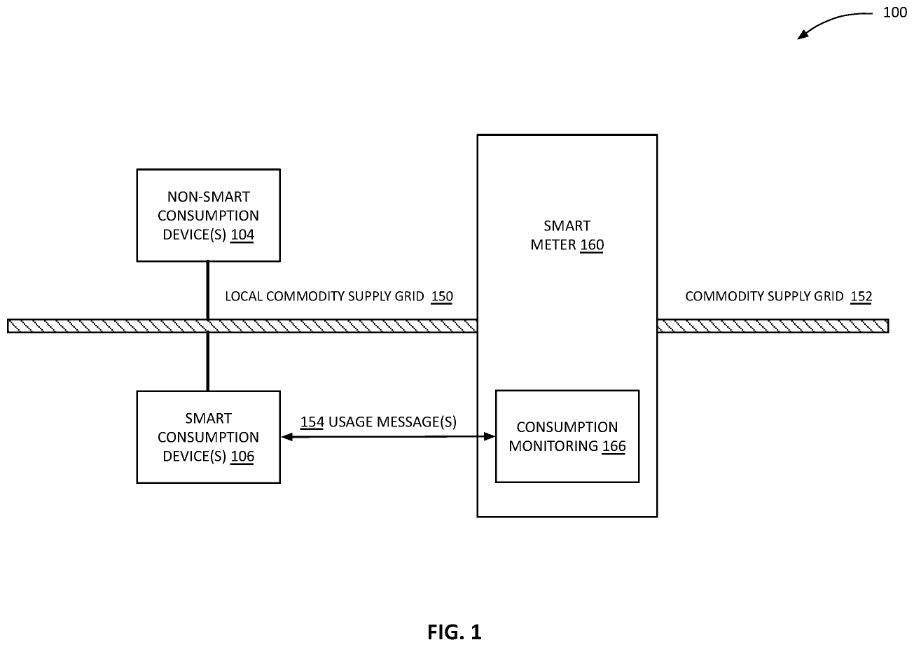

FIG. 1 is a conceptual illustration of a system 100 for determining consumption of a commodity by individual users according to some embodiments. The system 100 includes, without limitation, a non-smart consumption device 104, a smart consumption device 106, and a smart meter 160. The system 100 is installed at a shared facility (not shown), such as a residential dwelling. Both the non-smart consumption device 104 and the smart consumption device 106 are connected to a local commodity supply grid 150. The smart meter 160 controls the commodity flow from a utility (not shown) through a commodity supply grid 152 to the local commodity supply grid 150 and on to the non-smart consumption device 104 and the smart consumption device 106. The non-smart consumption device 104 and smart consumption device 106 operate independently. At any given time, each of non-smart consumption device 104 and smart consumption device 106 is either in a consuming state or a non-consuming state.

As used herein, non-smart consumption devices 104 are consumption devices that are not operable to communicate with the smart meter 160 but are able to consume a commodity from the local commodity supply grid 150. As used herein, smart consumption devices 106 are consumption devices that are operable to communicate 154 with the smart meter 160 and consume a commodity directly from the local commodity supply grid 150.

The local commodity supply grid 150 is any mechanism operable to deliver a commodity through a commodity supply grid 152 in a shared facility. Examples of commodities include electricity, gas, water, network bandwidth (or data), and/or the like.

A smart meter 160 is a digital utility meter used to measure and record commodity consumption in homes and businesses. Unlike traditional analog meters, smart meters 160 have remote communication capabilities, allowing them to send real-time usage data to utility companies, eliminating the need for manual readings and enabling features like time-of-use pricing, remote disconnect/reconnect, and outage detection. These smart meters 160 can provide the utility and consumers with detailed information about the consumer's energy usage, encourage energy conservation, and are often integrated into smart grid systems for improved efficiency and reliability in utility services. Consumption devices include any device consuming one or more of the aforementioned commodities, such as refrigerators, air conditioners, laptops, clothes washer, dryer, dishwasher, shower, toilet, smart TV, mobile devices, furnace, hot water heater, lawn irrigation, security cameras, lighting, etc.

The consumption monitoring 166 module monitors consumption by the non-smart consumption devices 104 and the smart consumption devices 106 and records the results as consumption data. The consumption data identifies the amount of a commodity consumed, the consumption device consuming the commodity, which user(s) consumed the commodity, and a time period during which the commodity was consumed. The consumption data is recorded at the smart meter 160 and can be periodically transmitted or sent to the utility for billing purposes.

A user initiates the consumption of a commodity at a smart consumption device 106 by interacting with the smart consumption device 106 and activating consumption by the smart consumption device 106. For example, the user can place wet clothes into a dryer (the smart consumption device 106 in this example) and indicate through manipulation of the physical controls on the dryer that the dryer should begin drying the clothes. The smart consumption device 106 transmits (i.e., sends) a notification to the smart meter 160 when the consumption begins and transmits another notification when the consumption ends (the clothes are finished drying and dryer). A smart consumption device 106 can also transmit information identifying the smart consumption device 106 (e.g., the make and model of the dryer for example). The smart meter 160 records the consumption data for the smart consumption device 106: the amount of commodity consumed, an identifier identifying user using the dryer, consumption device identifier, a start time, and a stop time.

Unlike smart consumption devices 106, non-smart consumption devices 104 lack the capability to notify the smart meter 160 when consumption begins and ends. However, the smart meter 160 is equipped with a non-intrusive load monitoring (NILM) module that enables the detection and identification of the usage of non-smart consumption devices 104. The non-intrusive load monitoring module relies on the collection and analysis of consumption occurring on local commodity supply grid 150. For example, in an embodiment where the commodity is electricity, the process begins with the collection of electrical data, typically through voltage and/or current sensors deployed at the smart meter 160 and/or various points within the grid. These voltage and/or current sensors continuously measure voltage and current waveforms, respectively, capturing the electrical signatures generated by the consumption devices connected to the local commodity supply grid 150. The next step involves signal processing, where advanced algorithms analyze the collected data, extracting crucial features and patterns that define each consumption device's unique electrical consumption fingerprint. With the help of machine learning techniques, the algorithms create a consumption device library of device signatures, enabling the algorithms to identify consumption devices based on the consumption device's distinctive power usage patterns.

As such, the non-intrusive load monitoring (NILM) module can detect when a non-smart consumption device 104 is consuming a commodity (start and stop times), the identity of the non-smart consumption device 104 consuming the commodity, and how much of the commodity the non-smart consumption device 104 consumes during the usage period. A set of users enabled to use a non-smart consumption device 104 is associated with the non-smart consumption device 104 at the smart meter 160, and usage of the commodity is assigned (e.g., allocating, dividing) to the users in the set based on a policy (e.g., an allocation policy). In some embodiments, the policy dictates that the consumption is divided evenly among the users in the set. The smart meter 160 records the consumption data for the usage of the non-smart consumption device 104, including the amount of commodity consumed, consumption device identifier, start time, stop time, and the user(s) responsible for the consumption based on the policy associated with the non-smart consumption device 104.

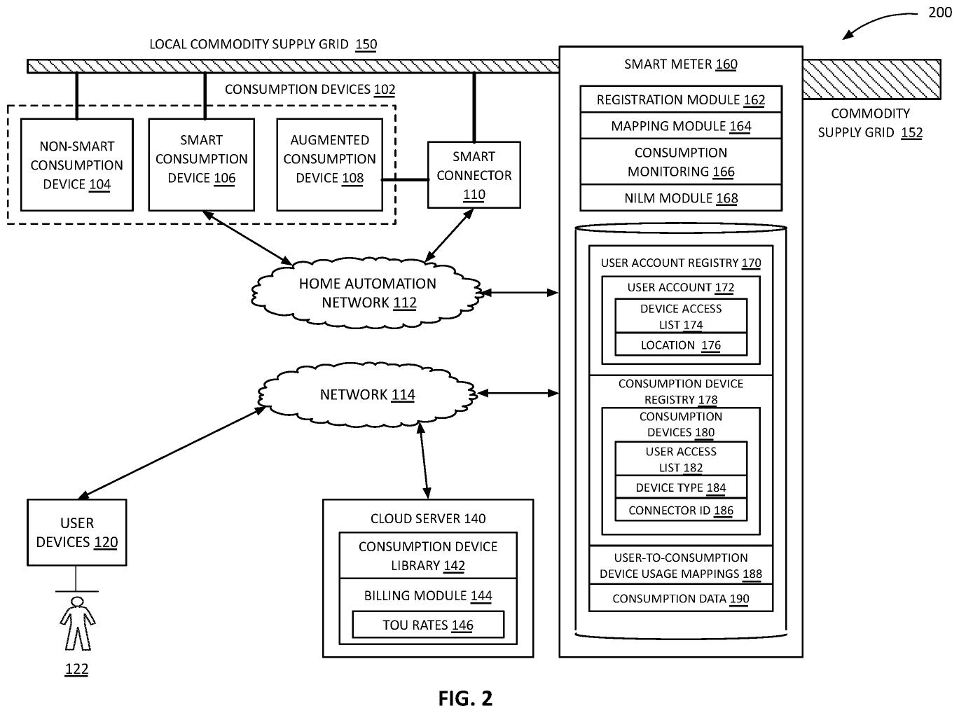

FIG. 2 is a block diagram of a system 200, according to some embodiments. System 200 includes, without limitation, smart meter 160, commodity supply grid 152, local commodity supply grid 150, one or more consumption devices 102, home automation network 112, network 114, one or more user devices 120, and cloud server 140. Consumption devices 102 include, without limitation, any combination of smart consumption devices 106, non-smart consumption devices 104, and augmented consumption devices 108. Cloud server 140 includes, without limitation, consumption device library 142, and billing module 144. billing module 144 includes without limitation time or use (TOU) rates 146. Smart meter 160 includes, without limitation, registration module 162, mapping module 164, consumption monitoring 166, NILM module 168, user account registry 170, consumption device registry 178, user-to-consumption device usage mappings 188, and consumption data 190. User account registry 170 includes, without limitation, user account 172. User account 172 includes, without limitation, device access list 174 and location 176. Consumption device registry 178 includes, without limitation, consumption devices 180. Consumption devices 180 includes, without limitation, user access list 182, device type 184, and connector ID 186.

System 200 includes the smart meter 160 and related infrastructure for monitoring consumption of a commodity (e.g., electricity, water, gas, network bandwidth) at a single location, such as a shared facility. The single location or shared facility could refer to multi-tenant housing, including various types of residential structures designed to accommodate multiple households or tenants within the same property. Common examples include apartments, condominiums, townhouses, duplexes and triplexes, cooperative housing, student housing, senior housing, military housing communities, and the like. However, the current techniques are not limited thereto. As used herein, a shared facility shall refer to any physical dwelling in which multiple users share occupancy and resources such as the aforementioned commodities.

As used herein, augmented consumption devices 108 are consumption devices 102 that are operable to indirectly connect to a home automation network 112 through a smart connector 110 and consume a commodity indirectly from the local commodity supply grid 150 through the smart connector 110.

A home automation network 112 is a communications network operable to couple, without limitation, smart consumption devices 106 and smart connectors 110 to the smart meter 160. In some embodiments, the home automation network 112 utilizes Ethernet, WIFI, Bluetooth, Zigbee, and the like, however the techniques described are not limited thereto. In some embodiments, one or more of the above network technologies are employed in combination by home automation network 112.

The network 114 is a communications network operable to couple smart meter 160 to the user devices 120 and the cloud server 140 over one or more local networks and/or the Internet. The network 114 enables user devices 120 and cloud server 140 to communicate with the smart meter 160 through a network interface present on the smart meter 160. The network interface can implement any technically feasible wired or wireless communications protocol to facilitate communications with the network 114. For example, network interfaces can include one or more of an optical network interface, a cable-network interface, an ethernet interface, a Wi-Fi transceiver, a Bluetooth™ transceiver, and/or the like. In some embodiments, the home automation network 112 and the network 114 are the same network.

One or more user devices 120 enable one or more users 122 to interact with the smart meter 160 for adding/modifying/deleting users 122, adding/modifying/deleting consumption devices 102, and assigning usage mapping policies for consumption devices 102. The user device 120 can be, without limitation, any type of computing device including a mobile phone, a tablet computer, a laptop computer, a desktop computer, and/or a smartwatch. In some embodiments, the one or more users 122 include any person who resides at the shared facility and/or is otherwise responsible for the consumption of and/or payment for consumption of a monitored commodity. For example, any of the user(s) 122 can be a person who lives at or otherwise spends time at the shared facility.

The user account registry 170 stores user account 172 information for each user 122 associated with a shared facility. The user account 172 information includes a device access list 174, and a location 176 history. The device access list 174 stores information identifying the consumption devices 102 a user 122 is allowed to use. In some embodiments, the default device access list 174 includes each of the consumption devices 102 or can be limited to each of the consumption devices 102 a corresponding user 122 is permitted to use to consume the commodity. In some embodiments, the default device access list 174 includes no consumption devices 102, and access must be added by a user 122 having administrative privileges to manage smart meter 160. The location 176 history stores one or more values indicating a location of the user 122. In some embodiments, location 176 can be determined by detecting when the user device 120 of a user 122 is connected to the network 114 and the location values can include, without limitation, “HOME” and “AWAY.” In some embodiments, location 176 is determined based on the location of a user device 120 of the user 122 and the values can be stored as GPS coordinates. In the case where more than one location 176 value is stored, the location 176 values are timestamped. Location 176 values can be aged out (i.e., removed from the location 176 history) based on the values respective timestamps when no longer needed by smart meter 160.

The registration module 162 registers users 122 with the user account registry 170. Registration of a user 122 includes adding, modifying, and deleting the user 122. Likewise, the registration module 162 registers consumption devices 102 in the consumption device registry 178. Registration of a consumption device 102 includes adding, modifying, and deleting the consumption device 108. In some embodiments, smart consumption devices 106 are operable to self-register with the registration module 162 upon connecting to the home automation network 112. In some embodiments, a user 122 with administrative rights registers and/or modifies the registration of consumption devices 102 with the registration module 162. The registration module 162 is also used to set policies for the users 122 and consumption devices 108. The registration module 162 is also used to configure and bind smart connectors 110 to consumption devices 102 through the connector ID 186.

The consumption device registry 178 stores consumption device 180 information for each consumption device 102 associated with the shared facility and includes a user access list 182, a device type 184, and a connector ID 186. The user access list 182 identifies users 122 authorized to use the respective consumption device 180. In some embodiments, the user access list 182, by default, includes all users 122. In some embodiments, by default, the user access list 182 is initialized without including any user(s) 122, and access must be added by a user with administration rights.

The device type 184 identifies the type of consumption device 180. Examples of device type 184 include, without limitation, smart consumption device 106, non-smart consumption device 104, and augmented consumption device 108. The connector ID 186 identifies the smart connector 110 used when the device type 184 of the consumption device 180 is an augmented consumption device 108.

The user-to-consumption device usage mappings 188, which are sometimes referred to as bindings, are used to determine which of the users 122 are assigned what portion of consumption for a consumption device 102 during a demand interval. As used herein, a demand interval refers to the time period over which consumption is measured and recorded in consumption data 190 for transmission to the utility. As used herein, a consumption period refers to the total continuous time of a single consumption and can span one or more demand intervals. The consumption data 190 identifies the amount of a commodity consumed, the consumption device 102 consuming the commodity, which user(s) 122 consumption of the commodity is assigned to, and a time period during which the commodity was consumed (e.g., the demand interval or a start time and end time). The consumption data 190 is recorded at the smart meter 160 and can be periodically transmitted to the cloud server 140 of the utility for use by the billing module 144. The consumption data 190 is recorded for each user 122 for each demand interval. Portions of the consumption data 190 can be aged out after successful transmission to the cloud server 140.

The mapping module 164 of the smart meter 160 establishes and maintains user-to-consumption device mappings 188 between the registered users 122 and the registered consumption devices 180. For smart consumption devices 106 or augmented consumption devices, the one or more users 122 responsible for the consumption are determined based on a user-to-consumption device usage mappings 188 policy setting that indicates the consumption is identified based on user confirmation or is determined automatically based on a splitting policy. In some cases, the splitting policy includes evenly splitting the consumption among all of the users 122 associated with the smart consumption device 106 or augmented consumption devices or alternatively based on percentages set by a user 122 when the smart consumption device 106 or augmented consumption device is registered (e.g., a first user 122 pays for 60% of usage and a second user pays for 40% of usage). For non-smart consumption devices 104, the one or more users 122 responsible for the consumption are determined based on a user-to-consumption device usage mappings 188 policy setting that indicates the consumption is determined automatically based on a splitting policy. In some cases, the splitting policy includes evenly splitting the consumption among all of the users 122 associated with the non-smart consumption devices 104 or alternatively based on percentages set by a user 122 when the non-smart consumption devices 104 is registered. In some cases, the current location 176 of the users 122 is checked, and the consumption of the commodity is split among the users 122 currently present at the shared facility. When location information is to be used to split the consumption, a use location flag in the user-to-consumption device usage mappings 188 policy is set.

In some embodiments, not all consumption devices are registered in the consumption device registry 178. As such, the consumption accounted for in the user-to-consumption device usage mappings 188 may not add up to one hundred percent of the consumption during a demand interval. In this scenario, the unaccounted-for consumption will be split between the user's 122 registered in the user account registry 170 and recorded in the consumption data 190 such that the consumption data 190 accounts for all of the consumption during the demand interval.

The consumption monitoring 166 module monitors consumption by all consumption devices 102 and records the results as consumption data 190 for each demand interval. In many scenarios, a consumption device 102 will consume a commodity across a time interval that spans multiple demand intervals and/or does not begin and/or end on demand interval boundaries. Thus, the consumption monitoring 166 module handles “breaking up” consumption sessions that span multiple demand intervals and recording consumption data 190 for each respective demand interval during the time interval.

In some embodiments, the NILM module 168 can be invoked by the registration module 162 during device registration to aid in detecting and identifying the universe of consumption devices 102 present on the local commodity supply grid 150. The detection occurs once the consumption devices have started consuming the commodity, but before registration is completed. A list of the consumption devices 102 detected by the NILM module 168 based on the invocation is presented through a user device 120 to a user 122 with administrative rights. The user 122 confirms the identification of the consumption devices 102 and select devices for registration and configuration. In some embodiments, the user 122 registers the consumption devices 102 manually. In addition, the NILM module 168 runs during each demand interval to detect and identify consumption by consumption devices 102. In the case of smart consumption devices 106 and augmented consumption devices 108, which are able to notify the smart meter when consumption begins and ends, the results from the NILM module 168 can serve as a check or backup. In the case of non-smart consumption devices 104 however, the results from the NILM module 168 are used to detect and identify the consumption by the non-smart consumption device 104.

The cloud server 140 provides services for an associated utility that supplies the commodity via commodity supply grid 152. the smart meter 160. The services include a consumption device library 142 and a billing module 144. The consumption device library 142 stores information identifying the usage signatures and operating characteristics of consumption devices 102. In some embodiments, the consumption device library 142 information is gathered from the NILM modules 168 operating at the various smart meters 160 across multiple shared facilities. In some embodiments, the consumption device library 142 information is provided by the manufacturers of the respective consumption devices 102 and transmitted to the NILM module 168 to aid in the detection and identification of consumption devices 102.

The billing module 144 automates the billing process. On a periodic basis, such as once each billing period (e.g., a month), the billing module 144 receives consumption data 190 from the smart meter 160. Using the consumption data 190 from the smart meter 160, individual billing statements are produced for each user 122 of the smart meter 160. The individualized billing statements can break down the amount of the commodity consumed by each user 122 over the billing period while also identifying the amount of consumption and by which consumption device 102. The billing process can use time of use (TOU) rates. TOU rates 146 are a type of commodity pricing structure used by utilities. In a TOU rate system, commodity costs vary depending upon the time of day and/or the day of the week, with higher rates during peak hours when demand for the commodity is high and lower rates during off-peak hours when demand for the commodity is lower. This pricing strategy is designed to encourage consumers to use a commodity during off-peak times, helping to balance demand on the commodity supply grid 152 and promote commodity conservation. The specific rate periods and pricing tiers can vary depending on the type of commodity, the utility provider, and/or geographic location of the shared facility.

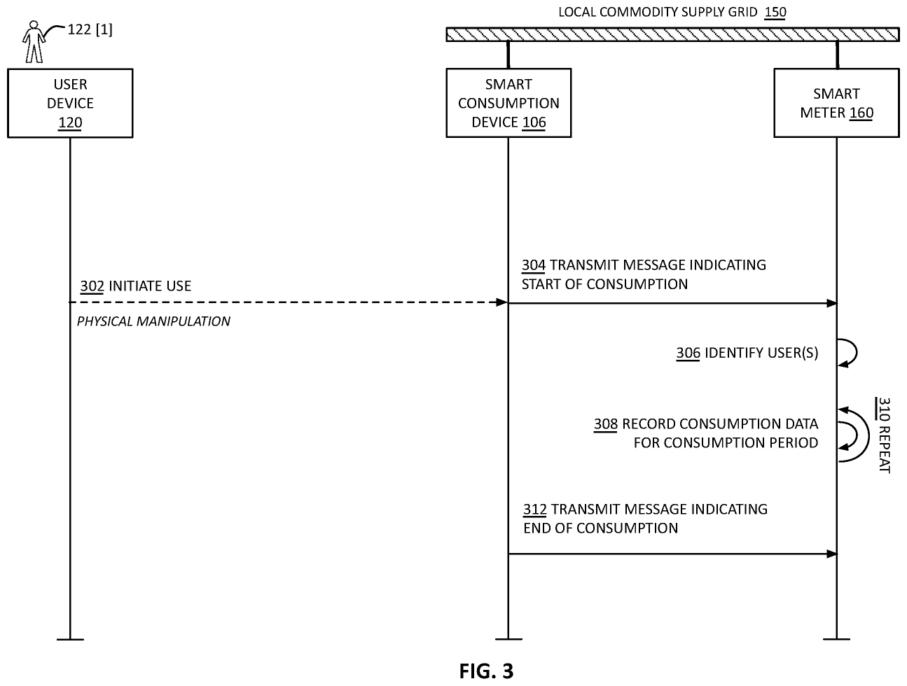

FIG. 3 is a conceptual illustration of a flow diagram for detecting and recording at a smart meter 160 the consumption of a commodity by a smart consumption device 106, according to some embodiments. The system of FIG. 3 includes, without limitation, a user device 120, smart consumption device 106, and a smart meter 160. The user device 120, smart consumption device 106, and smart meter 160 are enabled to communicate, without limitation, over the home automation network 112 and network 114. The smart consumption device 106 and smart meter 160 are both connected to local commodity supply grid 150.

The process flow of FIG. 3 begins at step 302, user 122 initiates consumption at the smart consumption device 106 through direct manipulation of physical controls at the smart consumption device 106, through an application running on the user device 120 and communicating over home automation network 112 and/or network 114 with the smart consumption device 106.

At step 304, the smart consumption device 106 transmits a message to the smart meter 160 indicating the start of consumption of a commodity by the smart consumption device 106. In preparation for subsequent steps 306-310, the consumption monitoring 166 module matches the smart consumption device 106 to the corresponding consumption device 180 in the consumption device registry 178.

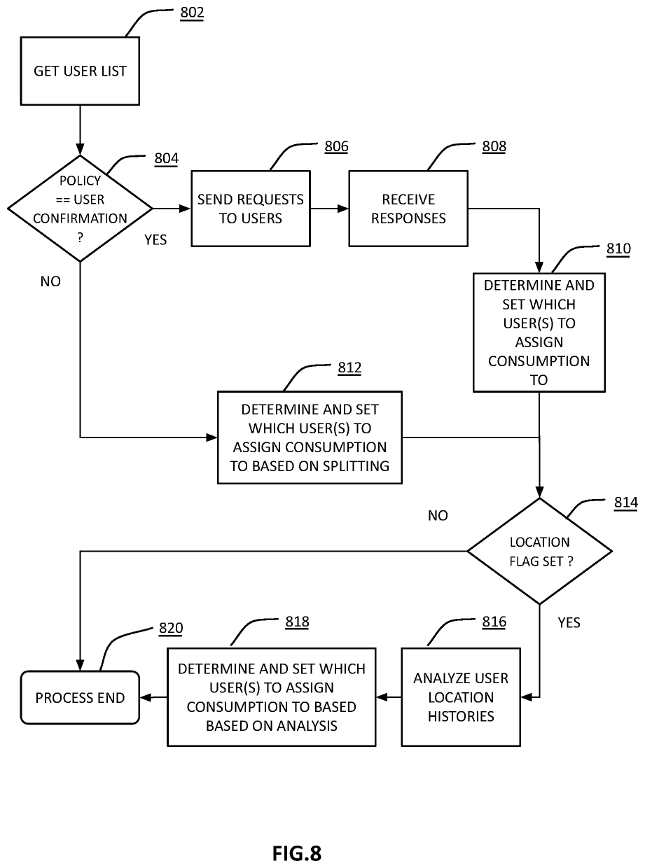

At step 306, the smart meter 160 identifies one or more users 122 responsible for the consumption at the smart consumption device 106. The users 122 allowed to use the smart consumption device 106 are identified in the user access list 182 of the consumption device registry 178. For smart consumption devices 106, the one or more users 122 responsible for the consumption are determined based on a user-to-consumption device usage mappings 188 policy setting that indicates the consumption is identified based on user confirmation or is determined automatically based on a splitting policy. In some cases, the splitting policy includes evenly splitting the consumption among all of the users 122 associated with the smart consumption device 106 or alternatively based on percentages set by a user 122 when the smart consumption device 106 is registered. In some cases, the current location 176 of the users 122 is checked and the consumption of the commodity is split among the users 122 currently present at the shared facility. When location information is to be used to split the consumption, a use location flag in the user-to-consumption device usage mappings 188 policy is set. Additional detail on identifying users responsible for consumption is shown in FIG. 8.

At step 308, the smart meter 160 records consumption data 190 identifying the consumption for one consumption period using the user-to-consumption device usage mappings 188 for the one or more users identified in step 306. Step 308 is repeated 310 multiple times if the consumption period spans multiple demand intervals. The consumption data 190 identifies the amount of a commodity consumed, the consumption device consuming the commodity, which user(s) consumed the commodity, and a time period during which the commodity was consumed. The consumption data 190 is recorded at the smart meter 160 and can be periodically transmitted to the utility for billing purposes.

At step 312, the smart consumption device 106 transmits a message to the smart meter 160 indicating the end of consumption of the commodity at the smart consumption device 106. Upon receiving the message indicating the end of consumption of the commodity by the smart consumption device 106, the smart meter 160 records the consumption for the final demand interval covered by the consumption, and the smart consumption device 106 becomes available for use by another user(s) 122.

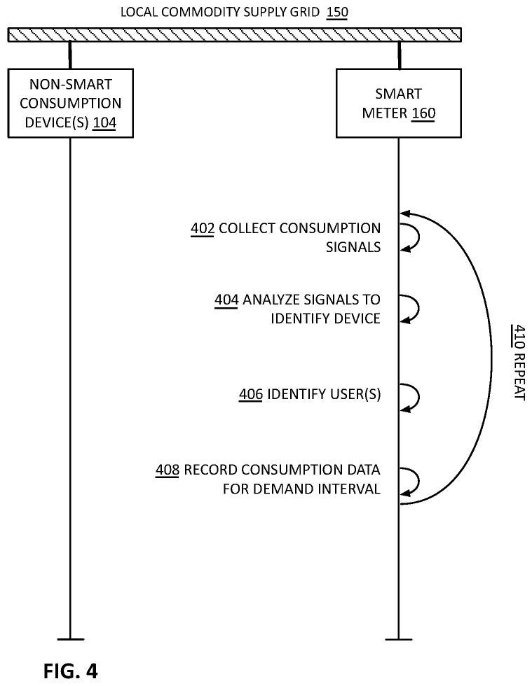

FIG. 4 is a conceptual illustration of a flow diagram for detecting and recording at a smart meter 160 the consumption of a commodity by a non-smart consumption device 104, according to some embodiments. The system of FIG. 4 includes, without limitation, a non-smart consumption device 104 and a smart meter 160. The non-smart consumption device 104 and smart meter 160 are both connected to local commodity supply grid 150.

The process flow of FIG. 4 begins at step 402, the smart meter 160 begins collecting consumption signals. The consumption signals are kept in memory at the smart meter 160 a can cover a time period covering some or all of the current demand interval and one or more past demand intervals. Consumption signals from past demand intervals can be aged out when no longer needed.

At step 404, the NILM module 168 analyzes the collected consumption signals to detect and identify a non-smart consumption device 104 that corresponds to a consumption device 180 registered in the consumption device registry 178. In preparation for subsequent steps 406-408, the consumption monitoring 166 module matches the non-smart consumption device 108 to the corresponding consumption device 180 in the consumption device registry 178.

At step 406, the smart meter 160 identifies one or more users 122 responsible for the consumption at the non-smart consumption device 104. The users 122 allowed to use the non-smart consumption device 104 are identified in the user access list 182 of the consumption device registry 178. For non-smart consumption devices 104, the one or more users 122 responsible for the consumption are determined based on a user-to-consumption device usage mappings 188 policy setting that indicates the consumption is determined automatically based on a splitting policy. In some cases, the splitting policy includes evenly splitting the consumption among all of the users 122 associated with the non-smart consumption devices 104 or based on alternatively percentages set by a user 122 when the non-smart consumption devices 104 is registered. In some cases, the current location 176 of the users 122 is checked, and the consumption of the commodity is split among the users 122 currently present at the shared facility. When location information is to be used to split the consumption, a use location flag in the user-to-consumption device usage mappings 188 policy is set. Additional detail on identifying users responsible for consumption is shown in FIG. 8.

For non-smart consumption devices 104, the one or more users 122 responsible for the consumption are determined based on a user-to-consumption device usage mappings 188 policy setting that indicates the consumption is identified based on splitting. The user-to-consumption device usage mappings 188 policy setting includes a flag indicating that if the user-to-consumption device usage mappings 188 should be adjusted based on location 176. Additional detail on identifying users responsible for consumption is shown in FIG. 8.

At step 408, the smart meter 160 records consumption data 190 identifying the consumption for one demand interval using the user-to-consumption device usage mappings 188 for the one or more users identified in step 406. At step 410, steps 402-408 are repeated for the next demand interval. The consumption data 190 is recorded at the smart meter 160 and can be periodically transmitted to the utility for billing purposes.

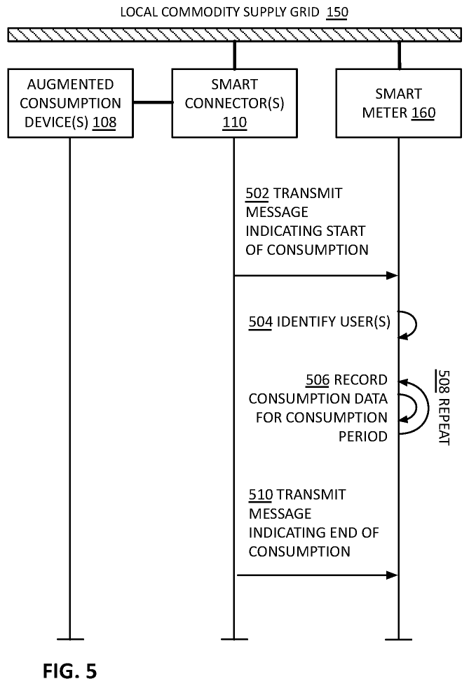

FIG. 5 is a conceptual illustration of a flow diagram for detecting and recording at a smart meter 160 the consumption of a commodity by an augmented consumption device 108, according to some embodiments. The system of FIG. 5 includes, without limitation, an augmented consumption device 108, smart connector 110, and a smart meter 160. The augmented consumption device 108 is connected to the local commodity supply grid 150 through the smart connector 110. The smart meter 160 is connected directly to the local commodity supply grid 150. User devices 120 are enabled to communicate with the smart connectors 110 through the home automation network 112 and network 114 without limitation.

The process flow of FIG. 5 begins at step 502, user 122 initiates consumption at the augmented consumption device 108 through direct manipulation of physical controls at the augmented consumption device 108. The augmented consumption device 108 transmits, using an associated smart connector 110, a message over network 112 to the smart meter 160 indicating the start of consumption of a commodity at the augmented consumption device 108. In preparation for subsequent steps 504-510, the consumption monitoring 166 module matches the smart consumption device 106 to the corresponding consumption device 180 in the consumption device registry 178.

At step 504, the smart meter 160 identifies one or more users 122 responsible for the consumption at the augmented consumption device 108. The users 122 allowed to use the augmented consumption device 108 are identified in the user access list 182 of the consumption device registry 178. For augmented consumption devices 108, the one or more users 122 responsible for the consumption are determined based on a user-to-consumption device usage mappings 188 policy setting that indicates the consumption is identified based on user confirmation or is determined automatically based on a splitting policy. In some cases, the splitting policy includes evenly splitting the consumption among all of the users 122 associated with the augmented consumption device 108 or alternatively based on percentages set by a user 122 when the augmented consumption device 108 is registered. In some cases, the current location 176 of the users 122 is checked, and the consumption of the commodity is split among the users 122 currently present at the shared facility. When location information is to be used to split the consumption, a use location flag in the user-to-consumption device usage mappings 188 policy is set. Additional detail on identifying users responsible for consumption is shown in FIG. 8.

At step 506, the smart meter 160 records consumption data 190 identifying the consumption for one demand interval using the user-to-consumption device usage mappings 188 for the one or more users identified in step 504. Step 506 is repeated 508 multiple times if the consumption period spans multiple demand intervals. The consumption data 190 identifies the amount of a commodity consumed, the consumption device consuming the commodity, which user(s) consumed the commodity, and a time period during which the commodity was consumed. The consumption data 190 is recorded at the smart meter 160 and can be periodically transmitted to the utility for billing purposes.

At step 510, the augmented consumption device 108 transmits, using the smart connector 110, a message to the smart meter 160 indicating the end of consumption of the commodity at the augmented consumption device 108. Upon receiving the message indicating the end of consumption of the commodity by the augmented consumption device 108, the smart meter 160 records the consumption for the final demand interval covered by the consumption, and the augmented consumption device 108 becomes available for use by another user(s) 122.

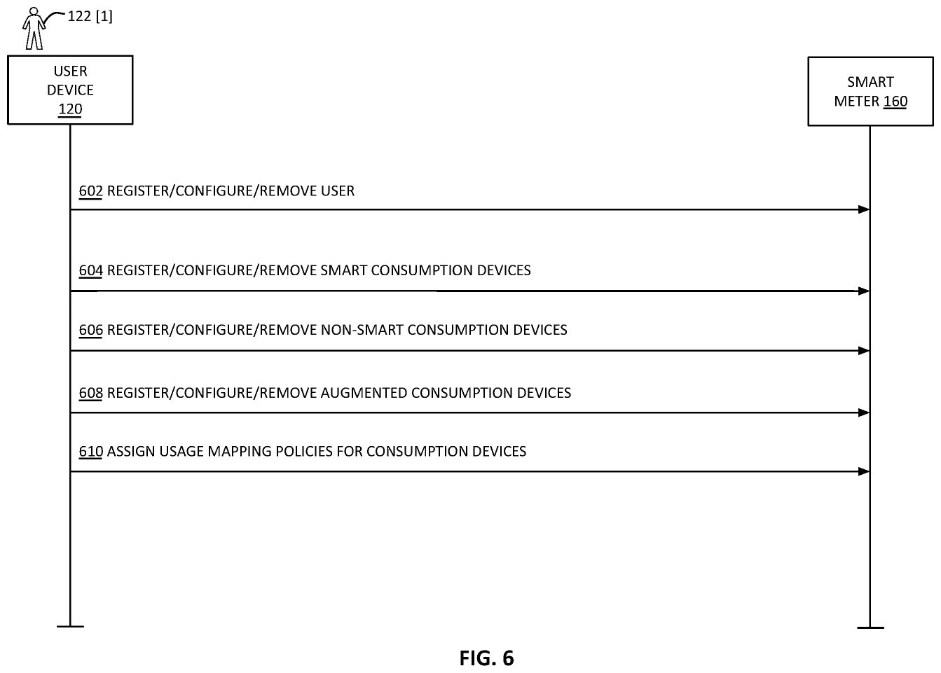

FIG. 6 is a conceptual illustration of a flow diagram for registering and configuring users 122 and consumption devices 102 with a smart meter 160, according to some embodiments. The system of FIG. 6 includes, without limitation, a user device 120 and smart meter 160 enabled to communicate over network 114.

At step 602, the user device 120 communicates with smart meter 160 to register a user 122. The registration includes creating a user account 172 for the user 122 in the consumption device registry 178. The user 122 is added to the user access list 182 of the consumption devices 180 the user 122 will use. All consumption devices 180 to which the user has access are included in the device access list 174 for the user account 172 for that user 122. A user 122 can also delete their user 122 account 172 from the smart meter 160. In some embodiments, only a user 122 with administrative rights can perform step 602.

At step 604, a user 122 registers and configures a smart consumption device 106 using registration module 162. In some embodiments, the smart consumption device 106 self-registers once connected to the home automation network 112, and the user 122 can modify the configuration for the smart consumption device 106 through interacting with the registration module 162 via a user device 120. The device type 184 identifies the device as a smart consumption device 106. After registration, the user 122 can also delete the smart consumption device 106 from the consumption device registry 178. Deleting the smart consumption device 106 removes the smart consumption device 106 from all device access list 174.

At step 606, a user 122 registers and configures a non-smart consumption device 104 using registration module 162. Unlike a smart consumption device 106, the non-smart consumption device 104 does not communicate on the home automation network 112 and is not able to self-register. The user 122 sets the device type 184 to identify the device as a non-smart consumption device 104. In some embodiments, the registration module 162 transmits the device type 184 set by the user 122 to the cloud server 140, and the cloud server 140 provides one or more consumption device 102 profiles based on the device type 184. The device type 184 can further indicate a specific type of the non-smart consumption device 104 (e.g., shower, toilet, furnace, hot water heater, etc. After registration, the user 122 can also delete the non-smart consumption device 104 from the consumption device registry 178. Deleting the non-smart consumption device 104 removes the non-smart consumption device 104 from each device access list 174 included in the user accounts 172.

At step 608, a user 122 registers and configures an augmented consumption device 108 using registration module 162. In some embodiments, the augmented consumption device 108 self-registers, using an associated smart connector 110, once connected to the home automation network 112, and the user 122 can modify the configuration for the augmented consumption device 108 through interacting with the registration module 162 via a user device 120. The device type 184 identifies the consumption device 102 as an augmented consumption device 108. After registration, the user 122 can also delete the augmented consumption device 108 from the consumption device registry 178. Deleting the augmented consumption device 108 removes the augmented consumption device 108 from each device access list 174. Part of registering an augmented consumption device 108 includes pairing an otherwise non-smart consumption device 104 with smart connector 110 to produce the augmented consumption device 108. The connector ID 186 identifies the smart connector 110 paired to an augmented consumption device 108. Each smart connector 110 can only be paired to one augmented consumption device 108. In some embodiments, only a user 122 with administrative rights can perform steps 604-608.

At step 610, a user 122 assigns user-to-consumption device usage mappings 188 policies for the consumption devices 102 registered in steps 604-608. In the case of smart consumption devices 106 and augmented consumption devices 108 the user-to-consumption device usage mappings 188 policy is based on user confirmation or splitting. A flag can also be used to indicate that the user-to-consumption device usage mappings 188 should be adjusted based on the location of users 122 when there is more than one user of a smart consumption devices 106 or augmented consumption devices 108. In the case of non-smart consumption devices 104 the user-to-consumption device usage mappings 188 policy are split (even or uneven percentages) and can also be adjusted based on the location of users 122 when a flag is set and there is more than one user of the non-smart consumption devices 104. In some embodiments, only a user 122 with administrative rights can perform step 610.

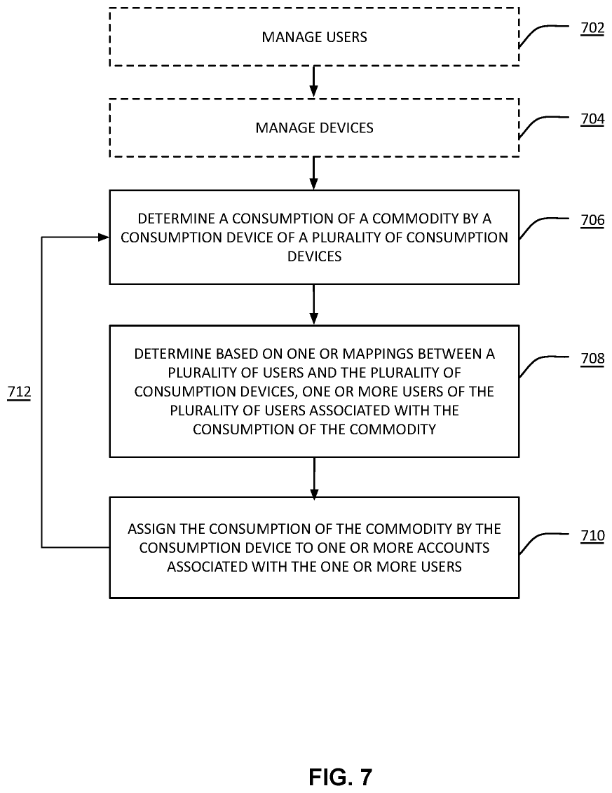

FIG. 7 is a flow chart of method steps for detecting and recording at a smart meter 160 the consumption of a commodity by multiple users 122 using multiple consumption devices 102, according to some embodiments. Although the method steps are described in conjunction with the systems of FIGS. 1-6, persons of ordinary skill in the art will understand that any system configured to perform the method steps, in any order, is within the scope of the present disclosure.

At step 702, user 122 manages users. User 122 uses user device 120 to interact with the registration module 162 of the smart meter 160 over network 114 to register, configure, and remove users 122. Users 122 are registered in the user account registry 170. Each user account 172 includes a device access list 174 including those consumption devices 102 from which the user is allowed to consume a commodity from using a consumption device 102. The registration includes creating a user account 172 for the user 122 in the consumption device registry 178. The user 122 is added to the user access list 182 of the consumption devices 180 the user 122 is allowed to use. In some embodiments, only a user 122 with administrative rights can perform step 702. Step 602 of FIG. 6 describes additional details of the actions performed during step 702.

At step 704, user 122 manages user devices 120. User 122 uses user device 120 to interact with the registration module 162 of the smart meter 160 over network 114 to register, configure, and remove consumption devices 102. Consumption devices 102 are registered in the consumption device registry 178 and the device type 184 and connector ID 186 are configured based on the type of consumption device 102 being registered (e.g., non-smart consumption device 104, smart consumption device 106, augmented consumption device 108). Each consumption device 180 includes a user access list 182 including those users 122 allowed to consume a commodity using a consumption device 102. Steps 604-610 of FIG. 6 describes additional details around step 704.

At step 706, the smart meter 160 determines a consumption of a commodity by a consumption device 102 of a plurality of consumption devices 102. In the case of a smart consumption device 106 the smart meter 160 receives one or more messages from the smart consumption devices 106 to determine that consumption of the commodity by the smart consumption device 106 is occurring. In some examples, the one or more messages are the messages associated with steps 304 and 312 described in FIG. 3. In the case of a non-smart consumption device 104, the NILM module 168 collects and analyzes consumption signals to determine whether a particular non-smart consumption device 104 is consuming the commodity. In some examples, the collection and analysis of consumption signals are associated with steps 402 and 404 in FIG. 4. In the case of an augmented consumption device 108 the smart meter 160 receives one or more messages from a smart connector 110 associated with the augmented consumption device 108 to determine that consumption of the commodity by the augmented consumption device 108 is occurring. In some examples, the one or more messages are the messages associated with steps 502 and 510 described in FIG. 5. The consumption data 190 recorded for the consumption can span multiple demand intervals. Additional detail on step 706 for augmented consumption device 108 is found in FIG. 5.

At step 708, the smart meter 160 determines based on one or more user-to-consumption device usage mappings 188 between a plurality of users 122 and the plurality of consumption devices 102, one or more users 122 associated with the consumption of the commodity. The one or more users 122 responsible for the consumption are determined based on a user-to-consumption device usage mappings 188 policy setting that indicates the consumption is identified based on user confirmation or splitting. The user-to-consumption device usage mappings 188 policy setting includes a flag indicating that if the user-to-consumption device usage mappings 188 should be adjusted based on location 176. Additional detail on identifying users responsible for consumption of the commodity by a consumption device is described below with respect to FIG. 8.

At step 710, the smart meter 160 assigns the consumption of the commodity by the consumption device 102 detected in step 706 to respective user account(s) 172 associated with the one or more users 122 determined during step 708. Once the consumption is assigned to the one or more users 122, the consumption is recorded in consumption data 190. The consumption data 190 identifies the amount of a commodity consumed, the consumption device consuming the commodity, which user(s) consumed the commodity, and a time period during which the commodity was consumed.

At step 712, steps 706-710 are repeated to cover each demand interval. Furthermore, steps 706-710 are repeated on each demand interval for other consumption devices 102 consuming a commodity during the demand interval. After executing steps 706-710, there can be unaccounted-for commodity consumption because not all consumption devices are registered in the consumption device registry 178. As such, the consumption accounted for in the user-to-consumption device usage mappings 188 may not add up to one hundred percent of the consumption during a demand interval. In this scenario, the unaccounted-for consumption is split between the users 122 registered in the user account registry 170 and recorded in the consumption data 190 such that the consumption data 190 accounts for all of the consumption during the demand interval. Steps 702 and 704 can be periodically repeated as users 122 can be registered and/or removed and consumption devices 102 can be registered and/or removed at any time.

FIG. 8 is a conceptual illustration of a flow chart for determining one or more users 122 to which to assign consumption of a commodity, according to some embodiments. Although the method steps are described in conjunction with the systems of FIGS. 1-7, persons of ordinary skill in the art will understand that any system configured to perform the method steps, in any order, is within the scope of the present disclosure. In some embodiments, FIG. 8 is an implementation of step 708. The assignment of consumption of a commodity is dictated by the user-to-consumption device mapping 188 policy set for the consumption device 102 consuming the commodity. The policy values available to a consumption device 102 are dictated by the device type 184. Smart consumption devices 106 and augmented consumption devices 108 can have the user confirmation policy or the splitting policy. Non-smart consumption devices can only have the splitting policy.

The process flow of FIG. 8 begins at step 802. The process is invoked to identify users 122 responsible for consumption by a consumption device 102. The flow of the flow diagram is dependent on the user-to-consumption device mapping 188 policy. In some cases, the current location 176 of the users 122 is checked, and the consumption of the commodity is split among the users 122 currently present at the shared facility. When location information is to be used to split the consumption, a use location flag in the user-to-consumption device usage mappings 188 policy is set.

At step 802, the mapping module 164 determines the users 122 listed on the user access list 182 for the consumption device 102 from the consumption device registry 178. In the case of smart consumption devices 106 or augmented consumption devices 108, the look-up is performed based on a unique identifier, such as a MAC address, transmitted by the smart consumption devices 106 or augmented consumption devices 108. In the case of a smart consumption device 106, the MAC address is the MAC address of the smart consumption device 106. In the case of an augmented consumption devices 108, the MAC address is the MAC address of the smart connector associated with the augmented consumption device 108. In the case of non-smart consumption devices 104, the look-up is performed based on a unique consumption signature detected by the NILM module 168 for the non-smart consumption devices 104.

At step 804, the mapping module 164 checks the user-to-consumption device mapping 188 policy for the consumption device 102. If the policy is set to user confirmation, the process continues at step 804. Otherwise, the policy is set to splitting and the process continues at step 814.

At step 806, the mapping module 164 transmits confirmation requests to the user device(s) 120 of the user(s) 122 listed on the user access list 182 for the consumption device 102 in the consumption device registry 178. A user device 120 receiving a request can present a notification to the user 122 of the user device 120 drawing attention to the request. The confirmation requests can include a response deadline, identifying a time period after which the confirmation requests are withdrawn.

At step 808, the mapping module 164 receives responses from the user devices 120 of the users 122 to which authentication requests were transmitted in step 804. In some instances, no users 122 respond to the confirmation requests, and the consumption device 102 will become available for subsequent use. In some instances, only one user 122 responds. In some instances, more than one (and possibly all) of the users 122 respond.

At step 810, the mapping module 164 determines and sets which user(s) to assign the consumption to. In the scenario where only one user 122 responds, the user-to-consumption device mapping 188 will indicate that the single user 122 is responsible for 100% of the consumption. In the scenario where more than one (and possibly all) of the users 122 will respond, the user-to-consumption device mapping 188 will indicate that the responding users 122 will collectively be responsible for the consumption (e.g., even or uneven split).

At step 812, the mapping module 164 determines and sets which user(s) to assign the consumption to based on a split. The split can be even or uneven. The split can be set be set by the user 122 during user registration, device registration, or at any time by modifying configuration settings at the smart meter 160.

At step 814, the mapping module 164 checks the user-to-consumption device mapping 188 policy location flag for the user-to-consumption device mapping 188 policy. If the use location flag is set, the process continues at step 816, otherwise, the process ends 820. The location flag can be set be set by the user 122 during user registration, device registration, or at any time by modifying configuration settings at the smart meter 160.

At step 816, the mapping module 164 analyzes the location 176 of the one or more users 122 identified in the user-to-consumption device mapping 188. The location 176 indicates a location of the user 122. In some embodiments, location 176 can be determined by detecting when the user device 120 of a user 122 is connected to the network 114 and the location values can include without limitation “HOME” and “AWAY.” In some embodiments, location 176 is determined based on the location of a user device 120 of the user 122 and the values can be stored as GPS coordinates.

At step 818, the mapping module 164 determines and sets which user(s) to assign the consumption to based on the location 176 analysis. For example, the user-to-consumption device mappings 188 can be adjusted based on the percentages of time each user in the user-to-consumption device mappings 188 was present during a demand period.

The process ends at step 820, and the flow continues with the system that invoked the flow of FIG. 8, for example, FIG. 3 at step 308, FIG. 4 at step 408, and FIG. 5 at step 508.

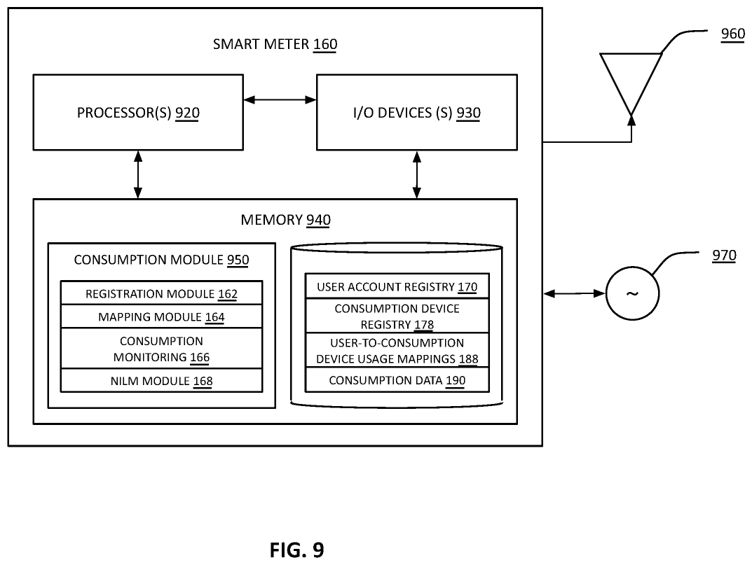

FIG. 9 illustrates an exemplary smart meter 160 that can be included in a mesh network and used to implement one or more aspects of the various embodiments discussed above with respect to FIGS. 1-8. Smart meter 160 includes, without limitation, one or more processors 920, one or more input/output (I/O) devices 930, one or more memories 940, one or more transceivers 960, and an oscillator 970.

Smart meter 160 is a network device and includes computing device hardware configured to perform various processing operations and execute program code. The smart meter 160 can further include various analog-to-digital and digital-to-analog converters, digital signal processors (DSPs), harmonic oscillators, transceivers, and any other components generally associated with RF-based communication hardware. In various embodiments, smart meter 160 includes a battery (not shown) that supplies power to the various computing device hardware included in smart meter 160.

The one or more processors 920 can include any hardware configured to process data and execute consumption module 950. At least one of the one or more processors 920 can include a real-time clock (RTC) (not shown) according to which processor 920 maintains an estimate of the current time. At least one of the one or more processors 920 executes consumption module 950.

The one or more I/O devices 930 include devices configured to receive input, devices configured to provide output, and devices configured to both receive input and provide output. In various embodiments, the one or more I/O devices include a keyboard, a mouse, a joystick, a touchpad, a touchscreen, a microphone, an inertial measurement unit (IMU), a display, a speaker, a haptic generator, or the like.

The one or more transceivers 960 can include one more interfaces that are associated with various communication media. In various embodiments, the one or more transceivers include at least one of a wireless radio frequency (RF) communication interface, Ethernet interface, a power line communication interface.

The memory 940 can be implemented by any technically feasible storage medium, including volatile and/or non-volatile storage media. Memory 940 includes, without limitation, the consumption module 950 and associated data. In general, the consumption module 950 include program code that, when executed by the one or more processors 920, performs any of the device management, user management, commodity consumption occurrence determination, user-to-consumption device usage mapping determination, commodity consumption assignment, and/or the like, such as the operations described above in conjunction with FIGS. 1-8. More specifically, the consumption module 950 includes without limitation registration module 162, mapping module 164, consumption monitoring 166, NILM module 168, and associated data, including without limitation user account registry 170, consumption device registry 178, user-to-consumption device usage mappings 188 and consumption data 190.

In sum, the disclosed techniques teach the use of commodity (e.g., electricity, gas, water, or network bandwidth) consumption devices and user devices (i.e., mobile phones) to aid in implementing per-user consumption identification. The users in a shared facility register with the smart meter to create a user account and establish communication between the smart meter and the user device. One or more of the users register smart consumption devices, non-smart consumption devices, and non-smart consumption devices augmented with smart connectors (i.e., augmented devices) with the smart meter. The smart meter establishes and maintains user-to-consumption device mappings between the registered users and the registered consumption devices. For smart consumption devices or augmented consumption devices, the one or more users responsible for the consumption are determined based on a user-to-consumption device usage mappings policy setting that indicates the consumption is identified based on user confirmation or is determined automatically based on a splitting policy. For non-smart consumption devices, the one or more users responsible for the consumption are determined based on a user-to-consumption device usage mappings policy setting that indicates the consumption is determined automatically based on a splitting policy. In some cases, the current location of the users is checked, and the consumption of the commodity is split among the users currently present at the shared facility. When location information is to be used to split the consumption, a use location flag in the user-to-consumption device usage mappings policy is set. As such, based on policies set by the one or more users, a user may not be charged for consumption device use (for example, HVAC) if they are not present in the shared facility for a period of time. The amount of a commodity consumed by each user is recorded periodically for each consumption device and can be used to provide a detailed accounting of the amount of a commodity consumed by each user for each consumption device. The detailed accounting can be used for billing and incorporate time-of-use (TOU) rates.

At least one technical advantage of the disclosed techniques is that the disclosed techniques provide for per-user commodity consumption isolation and identification without the need for expenditures in hardware submetering or commodity distribution infrastructure changes required to accommodate submetering. The techniques also support the addition or removal of users and/or consumption devices at any time, and not just at billing cycle boundaries. The techniques also work equally well for shared facilities without a granular mapping between consumption devices and/or other divisions (e.g., rooms in a shared facility).
1. In some embodiments a method comprises: determining, by a metering device, a consumption of a commodity by a consumption device of a plurality of consumption devices; determining, by the metering device based on one or more user-to-consumption device usage mappings between a plurality of users and the plurality of consumption devices, one or more users of the plurality of users associated with the consumption of the commodity; and assigning, by the metering device, the consumption of the commodity by the consumption device to one or more accounts associated with the one or more users.
2. The method of clause 1 wherein the commodity is one of electricity, gas, water, or network bandwidth.
3. The method of clauses 1 or 2 wherein the plurality of consumption devices includes any combination of non-smart consumption devices, smart consumption devices, or augmented consumption devices.
4. The method of any of clauses 1-3, wherein determining the consumption of the commodity by the consumption device comprises one or more of: receiving one or more messages from the consumption device identifying the consumption; or identifying the consumption based on nonintrusive load monitoring of a local commodity supply grid.
5. The method of any of clauses 1-4, wherein the one or more user-to-consumption device usage mappings include a mapping associating respective percentages of the consumption to the one or more users.
6. The method of any of clauses 1-5, wherein the respective percentages are a same percentage for the one or more users.
7. The method of any of clauses 1-6, wherein determining the one or more users based on the one or more user-to-consumption device usage mappings comprises: transmitting one or more confirmation requests to the plurality of users; and receiving respective confirmations from the one or more users.
8. The method of any of clauses 1-7, wherein determining the one or more users based on the one or more user-to-consumption device usage mappings comprises: determining respective locations of the plurality of users; and determining the one or more users based on the respective locations.
9. The method of any of clauses 1-8 further comprises: recording, by the metering device, the consumption of the commodity by the consumption device at the metering device as consumption data, wherein the consumption data identifies: an amount of the commodity consumed, the consumption device consuming the commodity, and a time period during which the commodity was consumed.
10. The method of any of clauses 1-9 further comprises: periodically transmitting the consumption data to a utility for billing purposes.
11. In some embodiments, one or more non-transitory computer-readable media storing instructions that, when executed by one or more processors, cause the one or more processors of a smart meter to perform operations comprises: detecting that a commodity is being consumed by a device; identifying, based on one or more bindings between users and devices, one or more users responsible for the consumed commodity; and allocating responsibility for the consumed commodity to the one or more users.
12. The one or more non-transitory computer-readable media of clause 11 wherein the commodity is one of electricity, gas, water, or network bandwidth.
13. The one or more non-transitory computer-readable media of clauses 11 or 12 wherein detecting that the commodity is being consumed by the device comprises one or more of: receiving one or more messages from the device indicating that the device is consuming the commodity; or detecting that the device is consuming the commodity based on nonintrusive load monitoring of a local commodity supply grid.
14. The one or more non-transitory computer-readable media of any of clauses 11-13 wherein the one or more bindings include a binding associating respective percentages of consumption of the commodity by the device to the one or more users.
15. The one or more non-transitory computer-readable media of any of clauses 11-14 wherein determining the one or more users based on the one or more bindings comprises: sending one or more confirmation requests to a plurality of users; and receiving respective confirmations from the one or more users.
16. The one or more non-transitory computer-readable media of any of clauses 11-15 wherein determining the one or more users based on the one or more bindings comprises: identifying respective locations of a plurality of users; and identifying the one or more users based on the respective locations.
17. In some embodiments, a metering device, comprises: a memory storing a consumption module; and a processor coupled to the memory that executes the consumption module to perform the steps of: identifying that a commodity is being consumed from a local commodity supply grid by a consumption device; dividing, based on a consumption allocation policy associated with the consumption device, identified consumption of the commodity into respective consumption portions to be allocated to one or more users; storing data indicating the respective consumption portions as consumption data; and periodically transmitting the consumption data to a utility or a user for billing purposes.
18. The metering device of clause 17 wherein the metering device is located between a commodity distribution grid and a local commodity supply grid coupling the metering device to a plurality of consumption devices.
19. The metering device of clauses 17 or 18, wherein dividing the identified consumption of the commodity based on the consumption allocation policy comprises: transmitting one or more request messages to a plurality of users; and receiving respective confirmation messages from the one or more users.
20. The metering device of any of clauses 17-19 wherein dividing the identified consumption of the commodity based on the consumption allocation policy comprises: receiving respective locations of a plurality of users; and identifying the one or more users based on the respective locations.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method comprising:
determining, by a metering device, a consumption of a commodity by a consumption device of a plurality of consumption devices;
determining, by the metering device based on one or more user-to-consumption device usage mappings between a plurality of users and the plurality of consumption devices, one or more users of the plurality of users associated with the consumption of the commodity; and
assigning, by the metering device, the consumption of the commodity by the consumption device to one or more accounts associated with the one or more users.

2. The method of claim 1, wherein the commodity is one of electricity, gas, water, or network bandwidth.

3. The method of claim 1, wherein the plurality of consumption devices includes any combination of non-smart consumption devices, smart consumption devices, or augmented consumption devices.

4. The method of claim 1, wherein determining the consumption of the commodity by the consumption device comprises one or more of:
receiving one or more messages from the consumption device identifying the consumption; or
identifying the consumption based on nonintrusive load monitoring of a local commodity supply grid.

5. The method of claim 1, wherein the one or more user-to-consumption device usage mappings include a mapping associating respective percentages of the consumption to the one or more users.

6. The method of claim 5, wherein the respective percentages are a same percentage for the one or more users.

7. The method of claim 1, wherein determining the one or more users based on the one or more user-to-consumption device usage mappings comprises:
transmitting one or more confirmation requests to the plurality of users; and
receiving respective confirmations from the one or more users.

8. The method of claim 1, wherein determining the one or more users based on the one or more user-to-consumption device usage mappings comprises:
determining respective locations of the plurality of users; and
determining the one or more users based on the respective locations.

9. The method of claim 1 further comprising:
recording, by the metering device, the consumption of the commodity by the consumption device at the metering device as consumption data, wherein the consumption data identifies: an amount of the commodity consumed, the consumption device consuming the commodity, and a time period during which the commodity was consumed.

10. The method of claim 9 further comprising:
periodically transmitting the consumption data to a utility for billing purposes.

11. One or more non-transitory computer-readable media storing instructions that, when executed by one or more processors, cause the one or more processors of a smart meter to perform operations comprising:
detecting that a commodity is being consumed by a device;
identifying, based on one or more bindings between users and devices, one or more users responsible for the consumed commodity; and
allocating responsibility for the consumed commodity to the one or more users.

12. The one or more non-transitory computer-readable media of claim 11 wherein the commodity is one of electricity, gas, water, or network bandwidth.

13. The one or more non-transitory computer-readable media of claim 11 wherein detecting that the commodity is being consumed by the device comprises one or more of:
receiving one or more messages from the device indicating that the device is consuming the commodity; or
detecting that the device is consuming the commodity based on nonintrusive load monitoring of a local commodity supply grid.

14. The one or more non-transitory computer-readable media of claim 11 wherein the one or more bindings include a binding associating respective percentages of consumption of the commodity by the device to the one or more users.

15. The one or more non-transitory computer-readable media of claim 11 wherein determining the one or more users based on the one or more bindings comprises:
sending one or more confirmation requests to a plurality of users; and
receiving respective confirmations from the one or more users.

16. The one or more non-transitory computer-readable media of claim 11 wherein determining the one or more users based on the one or more bindings comprises:
identifying respective locations of a plurality of users; and
identifying the one or more users based on the respective locations.

17. A metering device, comprising:
a memory storing a consumption module; and
a processor coupled to the memory that executes the consumption module to perform the steps of:
identifying that a commodity is being consumed from a local commodity supply grid by a consumption device;
dividing, based on a consumption allocation policy associated with the consumption device, identified consumption of the commodity into respective consumption portions to be allocated to one or more users;
storing data indicating the respective consumption portions as consumption data; and
periodically transmitting the consumption data to a utility or a user for billing purposes.

18. The metering device of claim 17 wherein the metering device is located between a commodity distribution grid and a local commodity supply grid coupling the metering device to a plurality of consumption devices.

19. The metering device of claim 17, wherein dividing the identified consumption of the commodity based on the consumption allocation policy comprises:
transmitting one or more request messages to a plurality of users; and
receiving respective confirmation messages from the one or more users.

20. The metering device of claim 17 wherein dividing the identified consumption of the commodity based on the consumption allocation policy comprises:
receiving respective locations of a plurality of users; and
identifying the one or more users based on the respective locations.
